(19) United States
(12) Patent Application Publication
(10) Pub. No.: US 2024/0396390 A1
(43) Pub. Date: Nov. 28, 2024

(54) ALTERNATIVE POWER GENERATION (APG) SYSTEM

(71) Applicants: Emmanuel G. Moya, Milford, PA (US); Victor E. J. Moya, Burlington, ON (CA)

(72) Inventors: Emmanuel G. Moya, Milford, PA (US); Victor E. J. Moya, Burlington, ON (CA)

(21) Appl. No.: 18/670,809

(22) Filed: May 22, 2024

Related U.S. Application Data
(60) Provisional application No. 63/503,857, filed on May 23, 2023.

(51) Int. Cl. H02K 1/2746; H02J 3/00; H02J 3/32; H02J 3/38; H02J 9/06; H02K 1/17; H02K 16/02

(52) U.S. Cl. CPC H02K 1/2746; H02J 3/0073; H02J 3/32; H02J 3/381; H02J 9/062; H02J 9/066; H02J 9/068; H02K 1/17; H02K 16/02; H02J 2300/10; H02J 2300/24; H02J 2300/28

(57) ABSTRACT

An Alternative Power Generation (APG) System employs an Automatic Transfer Switch (ATS) that connects an electric power utility to an electrical load in an ‘On-Grid’ mode. The ATS can also connect a branch that has renewable power sources to the load to supplement power from the grid. The ATS may also cut off power from the grid and only use power from the renewable power sources in an ‘Off-grid’ mode. The renewable power sources are solar, wind turbine, biogas electric power generators, as well as a Magternator. A Magternator employs a rotating inertial disk on a shaft with angled rotating magnets that rotates adjacent to a stationary disk having fixed magnets. The Magternator is driven by an electric motor that is powered by storage batteries. The interaction of the magnets causes levitation of the Magnetic Generator shaft, reducing friction and providing a rotation force to the rotating disk.

### CROSS-REFERENCE TO RELATED APPLICATIONS

This application claims priority to U.S. Provisional Patent Application 63/503,857 “Alternative Power Generation (APG) System”, filed May 23, 2023 by Emmaneul Moya and Victor Moya, and incorporated its content as if set forth in full here, to the extent that it does not contradict any material of this application.

### STATEMENT REGARDING FEDERALLY SPONSORED RESEARCH

Not applicable.

### BACKGROUND OF THE INVENTION

### 1. Field of the Invention

The current invention relates to a system for generating electric power and, more specifically, to a system for generating electric power in various locations, such as third-world countries where the electric power grid is unreliable.

### 2. Discussion of Related Prior Art

Demand for electric power and electric power backup systems for residences has increased significantly. Infinite overall market size for backup and regular power generation encompasses the need for humanity to look beyond the possibility of providing power without the necessity of using fossil fuel but from renewable energy. Conventional brands for residential use, such as Generac, Kohler, Honda, Briggs and Stratton, and Duromax and Commercial/industrial such as Detroit-Allison, Caterpillar, and GE Janbacker, depend on fossil fuels. There is a need for residential power backup systems that employ one or more renewable energy sources, such as biogas, solar, wind, and flywheels.

Our modern society depends on the electricity grid, and major outages may have severe consequences. With the ever-increasing prices of fossil fuels used in power generation, we are determined to obtain other potential reliable sources of power. Reliable energy sources are especially important for communities, universities, military bases, and other areas with critical urban functions, such as hospitals, police, and fire stations, where public safety may be compromised by electrical power outages. Although backup generation is common in critical facilities, failure of backup production resources due to lack of maintenance or insufficient fuel supply is very common. Advanced microgrids can be an effective solution for transmitting power to critical infrastructure. The simple definition of a micro-grid is a set of loads or electric customers with local power generation that can be disconnected from the mains grid as described in {[14]} Fundamentals of Advanced Micro-grid Design, Sandia National Laboratories, 2019.

Micro-grids can be categorized into three main groups:
Backup Only Micro-grids, which are sized to cover critical loads only and operate when the main grid is down,
Always Islanded Micro-grids, which are designed for a remote system far from the main grid and never connected to the main grid,
Hybrid Micro-grids, which operates both on-grid and off-grid based on the factors such as cost, main grid outage or fuel supplies.

A microgrid must have the capability to operate flexibly and efficiently. Some essential capabilities include:
Flexibility in placement and technologies related to power generation sources, including distributed generation, renewable energy, and energy storage, by considering the low energy cost and high reliability,
Complex controls, including dynamic power quality control and automatic control to provide high-quality power efficiency in off-grid mode,
System robustness to provide continuous operation in off-grid mode,
Efficient operation by matching the total generation to the microgrid load.

Micro-grid implementations may also require the following alterations:
Additional transformers/breakers/controls to existing generator resources,
New generation resources,
Static switch/main breaker,
Sectionalizing switches/breakers,
Energy storage,
Micro-grid controls,
Protection against fault conditions.

The ever-increasing price of fuel that feed our electrical grid have reached peak levels that consumers all over the world are having hard times to meet. The war between Russia and Ukraine, had a high positive impact on this increase, limiting supply of fuel and resources. OPEC countries' dominate and control of crude oil, leaving consumers at their mercy, worsening anxiety of every consuming public. The advent of alternatives power resources from solar, wind turbines biofuels and hydrogen have not helped much in lowering the costs of power generation.

Limitations of each of the available renewable resources are listed below.

### 1) Solar Panels:

requires a considerable area to produce enough power for a typical household and/or commercial business,
limited time of power generation, entirely depended on sunlight,
short effective performance life.

### 2) Wind Turbines:

requires height to generate power limited in generating power.
dependent on wind velocity.

### 3) Other Kinds of Turbines:

requires only mechanical to electrical conversions, and
too limited in power generation.

### 4) Gas or Biofuel Generators:

noise level limitations in urban areas,
gas exhaust,
requires gasoline, diesel, and other biogas.

Each of these power generation systems are good options for generating electric power, subject to their limitations. However, if we combine any two of these technologies will result in improved power generation, with a much smaller footprint and much higher efficiency. Combinations will result in the shortest ROI (Return of Investment) considering initial creation costs and the operational life of the equipment.

Currently, there is a need to generate electric power serve not only for countries that have a reliable electric grid, but also for the rich nations and affluent communities, but also the third world developing countries, that have unreliable electric grids.

The current invention may be embodied as

### SUMMARY OF THE INVENTION

Power from an electric power utility on the electric power grid is distributed to an electrical load. A Magnetic Power Generator (which also may be referred to as a “Permanent Magnet Generator” or a “PM Generator”) and renewable electric power sources are connected to the system for the purpose of reducing the amount of power drawn from the utility and/or for supplementing power to meet the needs of the load. The Magnetic Power Generator and renewable electric power sources are connected through an Automatic Transfer Switch (ATS).

This results in the generator multiplying the power applied to a load.

A load-sensing mechanism senses a load and provides feedback to a Variable Frequency Drive (VFD) Controller that drives an electric motor. VFD Controller controls the motor to slow down or speed up the Magnetic Power Generator commensurate to the load.)

The VFD Controller controls the motor to start with a ‘Soft Start’ from low current ramping up a higher current to provide the current needed by the motor to start and run the Magnetic Generator.

A small amount of current is also sent to a charger/controller to charge a Bank of Batteries. The Bank of Batteries stores power to switch the ATS from connection to the electric power grid to battery power start and run the Magnetic Generator.

A dump load mechanism is used to either neutralize excess load, or route it back to the electric power grid for electric power credit.

The current invention may also be embodied as an Alternative Electric Power Generation (APG) System 1000 to supplement electric power to a load in locations that experience intermittent electric power from an electric power grid, having a line input that provides electric line power from the electric power grid, at least one alternative power source that creates electric power, an automatic transfer switch (ATS) coupled to the line input, at least one alternative power source, and a load, that senses electric power being received at the input line and switches to connect the at least one alternative power source to the load when the line power is unavailable. Wherein the alternative power source may be at least one of a:
solar energy electrical generation device that converts solar energy into electric power,
gas generator that burns gas and creates electric power,
wind generator that creates electric power from wind; and
magternator that creates electric power from a rotating motor shaft.

The magternator includes an inertial disk assembly having at least one inertial disk on a rotatable shaft, with a plurality of elongated rotating permanent magnets, each having a north pole and a south pole at each end, attached to the inertial plate in regular intervals around its periphery.

The magnerator also includes a stationary plate 30 coplanar with, and concentrically surrounding each inertial disk, having a plurality of elongated stationary permanent magnets having a north pole and a south pole at each end, attached to the stationary plate such that the north pole of the rotating magnets passes closely by the north pole of the stationary magnets causing repulsion between the magnets causing the magnets to repel each other.

### BRIEF DESCRIPTION OF THE DRAWINGS

It will be appreciated that the illustrated boundaries of elements in the drawings represent only one example of the boundaries. One skilled in the art will appreciate that a single element may be designed as multiple elements or that multiple elements may be designed as a single element. An element shown as an internal feature may be implemented as an external feature and vice versa.

Further, in the accompanying drawings and descriptions that follow, like parts are indicated throughout the drawings and description with the same reference numerals. The figures may not be drawn to scale, and the proportions of certain parts have been exaggerated for the convenience of illustration.

FIG. 1 is a general simplified system block diagram of the Alternative Power Generation (APG) System according to one embodiment of the current invention.

FIG. 2A is a simplified block diagram of an embodiment of a variable frequency drive (VFD) of FIG. 1.

FIG. 2B is a simplified block diagram of an embodiment of a direct mechanical link between the electric motor and the Magnetic Generator according to the current invention.

FIG. 2C is a simplified block diagram of a different embodiment of the current invention having a mechanical V-belt drive between the electric motor and the Magnetic Generator.

FIG. 2D is a simplified block diagram of another embodiment of a direct mechanical link between the electric motor and the Magnetic Generator, which has a reversing mechanism according to the current invention.

FIG. 3 is a perspective, partially cut-away view of the Magnetic Generator of FIG. 1 that is compatible with the current invention.

FIG. 4 is a front elevational view of the APG System of FIG. 1 that is compatible with the current invention.

FIG. 5 is an alternative embodiment of the current invention having a more detailed and enlarged diagram of a portion of the APG System of FIG. 1.

FIG. 6 is a simplified block diagram of an alternative embodiment of the current invention.

FIG. 7 is a front elevational view of another embodiment of the current invention used to illustrate its operation.

FIG. 8 is a plan view of a reversing magnetic disk used to reduce the friction in a Magnetic Generator.

FIG. 9 is a side elevational view of a portable embodiment of the current invention employing a Magternator employing V-belt pulleys.

FIG. 10 is a perspective view of another embodiment of the current invention.

FIG. 11 is an elevational view of the embodiment of the current invention shown on FIG. 10.

FIG. 12 is a top plan view of the embodiment of the current invention shown on FIGS. 10 and 11.

FIG. 13 is an enlarged partial view of the generator portion of the embodiment of FIGS. 10, 11 and 12.

FIG. 14 is a perspective view of another embodiment of the current invention employing compressed air.

FIG. 15 is a front elevational view of the embodiment of FIG. 14.

FIG. 16 is a top plan view of the embodiment shown in FIGS. 14 and 15.

### DETAILED DESCRIPTION OF A PREFERRED EMBODIMENT

### 1. Theory

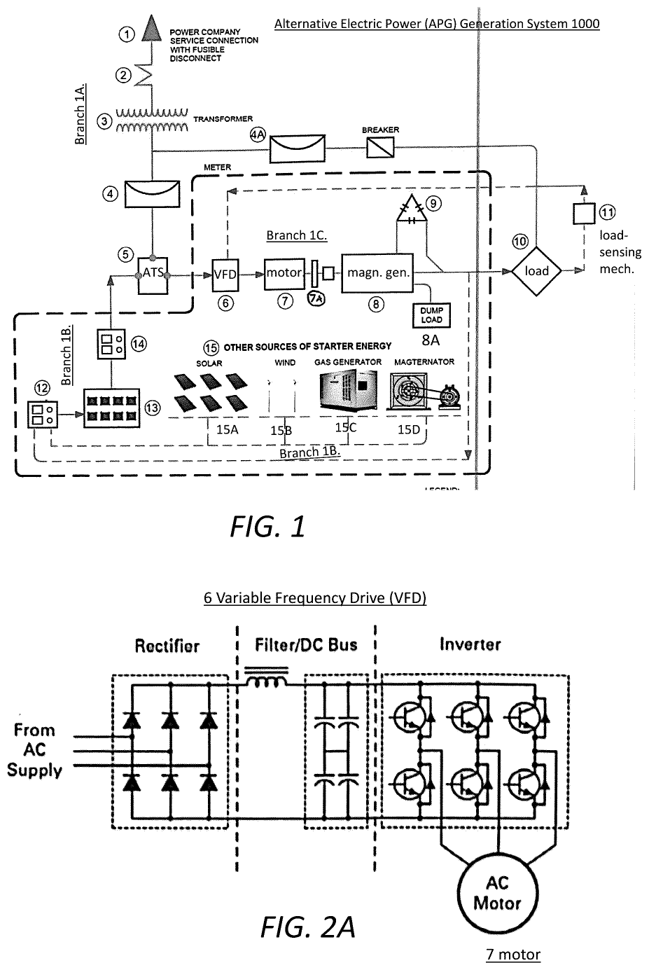

An Alternative Electrical Power Generation (APG) System, according to the present invention, is an advanced on-grid/off-grid system, as shown in FIG. 1. The APG system 1000 includes a variable speed drive (VFD) controller 6 controlling an electric motor 7 coupled to a Magnetic Generator 8, the load of which is sensed by a feedback load sensing mechanism 11. (In alternative embodiments, other conventional motors, such as gasoline or propane-powered motors, may be used in place of the electric motors shown and described throughout this application.) An automatic transfer switch (ATS) 5 has been employed for safe switching between the on-grid and off-grid operations.

The VFD 6 has been designed to provide a soft-starting condition to the electric motor 7 by changing the frequency (speed) from a low starting level to the rated value to develop the required torque to run the generator. Whenever the generator reaches the rated frequency and voltage, it can operate continuously at the rated condition. The load sensing mechanism 11 with feedback has been developed to adjust the required speed and torque according to the applied load to the system 1000. The generator's excess power can be neutralized via a dump load mechanism or fed back to the grid for credit. A bank of capacitors is used to correct the low lagging power factor caused by Inductive loads.

A small portion of the generated current is sent to a battery charger/controller unit 12 to charge the bank of storage batteries 13 and store the power to start up and run the generator for off-grid operation. Solar power 15A, wind power 15B, gas generators 15C, and a Magternator 15D can also be an alternative source in off-grid operation.

### 1) Automatic Transfer Switch

An Automatic Transfer Switch (ATS) 5 is a self-acting, power-switching device to transfer the load (electrical equipment) 10 connection between the primary (utility), branch 1A and secondary (generator) sources branch 1B of electrical power without any discontinuity. Typically, an ATS controller 5 constantly monitors the voltage and frequency of the primary and alternate power sources (branches 1A and 1B) and will only connect to the alternate power source (branch 1B) when required or requested by the operator.

Careful selection of an ATS 5 is important to ensure its reliability and capability in primary and alternate operations. Some of the main characteristics are the voltage, current ratings, and type of load. It is recommended that the current rating for ATS 5 match that of the main circuit breaker 2 in the electrical control panel. Since an ATS 5 is connected to two different power sources, it must handle the increased voltage stress.

### 2) Variable Frequency Drive 6 and Motor 7

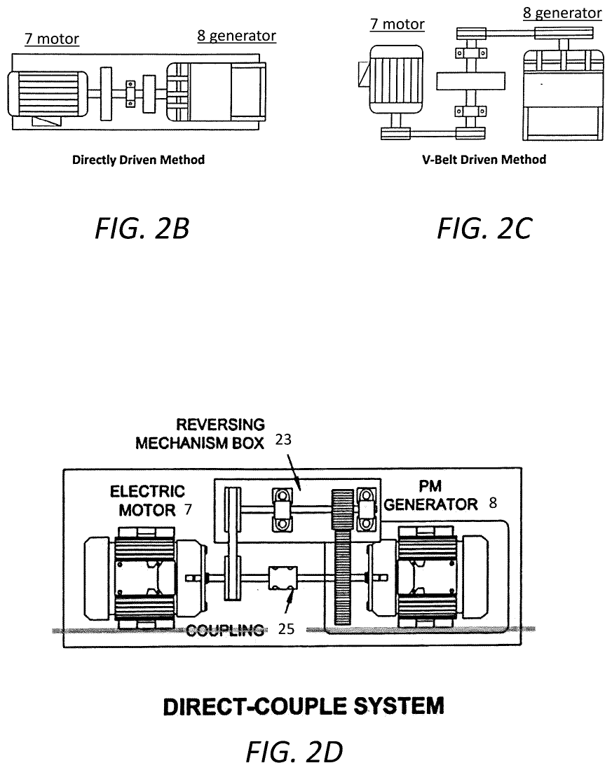

FIG. 2A is a simplified block diagram of an embodiment of a variable frequency drive (VFD) 6 of FIG. 1. The VFD 6 is a device that controls the voltage and frequency supplied to a motor 7. Therefore, VFD 6 controls the speed of motor 7 and the system it is driving. The speed of motor 7 and the frequency are related as indicated by Eq. (1) below:

$$n = 120 f / P \qquad Eq . ( 1 )$$

where:
n: speed (rpm)
f: frequency (Hz)
P: number of poles in stator

Since the number of poles is constant, changing the frequency can control the motor speed. For example, a four-pole motor operating at 60 Hz has a speed of 1800 rpm.

Any VFD 6 consists of three stages: Rectifier, DC Bus, and Inverter {[1]} as disclosed in Design and Analysis of a Permanent Magnet Generator for Naval Applications, Eaton Corporation, 2013.

### FIG. 2A: Typical VFD Diagram

As shown in FIG. 2A, in the VFD, a rectifier converts the AC supply voltage into DC voltage. The DC voltage employs filter capacitors to smooth voltage ripples to provide clean DC power. This section of the VFD is often referred to as the DC Bus.

The DC voltage is then converted back into AC in the inverter using a set of IGBT power transistors and the Pulse Width Modulation (PWM) technique. The entire process is controlled by a microprocessor, which monitors the Incoming voltage supply, speed set-point, DC link voltage, output voltage, and current to maintain a constant voltage-to-frequency ratio.

The use of VFD 6 can cause some effects, which must be considered for successful operation of the overall system. For instance:
Motor Cooling: The ability of motor 7 to cool Itself is effectively reduced at low-speed operations. Therefore, external force air ventilation may be required at low speeds and high loads. A small air conditioning system is incorporated in the design to cool down the magnets in these conditions.
Vibration and Resonance: Operation at different speeds/frequencies can cause mechanical resonance in driven equipment. Therefore, these speeds should be identified and removed from the motor's operating range.
Harmonics: VFD generates harmonic voltages and currents, which can cause undesirable effects on the system and affect equipment operation. Therefore, isolation transformers or filtering devices may be required to minimize these effects.

### 3) Motor and Generator Shafts' Connection

Two different approaches have been considered in this system, a direct drive method and a V-belt drive method, as shown in FIGS. 2B and 2C, respectively.

FIG. 2B is a simplified block diagram of an embodiment of the direct mechanical link between the electric motor 7 and the Magnetic Generator 8 according to the current invention.

The torque developed in the motor 7 shaft must be transmitted to the Magnetic Generator 8 by connecting their shafts.

In the direct drive setup, motor 7 and generator 8 are placed in series. Their shafts are aligned horizontally and connected by a disk coupling, which is appropriate for transferring high torques.

Direct Drive Method with V-Belt Drive

FIG. 2C is a simplified block diagram of a different embodiment of the current invention, having a mechanical V-belt drive between the electric motor 7 and the Magnetic Generator 8. In the V-Belt drive mechanism, motor 7 and generator 8 are placed in parallel, and their shafts are connected via two V-belts and an extra intermediate transmission shaft.

In the direct drive method, the generated torque and speed are directly transferred through the coupling.

In FIG. 2C, the V-belt drive method, the transferred speed and torque depend on the employed sheaves' diameters ratio. The speed ratio, minimum sheave diameters, and the required belt size can be determined from the following formulas by considering the provided service factor in Eq. (2):

$$Speed Ratio = \frac{D}{d} or Speed Ratio = \frac{{n}_{d}}{{n}_{D}} \\ Belt Size = 2 C + \frac{π}{2} ( D + d ) + \frac{{( D - d )}^{2}}{4 C} \qquad Eq . ( 2 )$$

where
D: Outer Diameter of Large Sheave (in),
d: Outer Diameter of Small Sheave (in),
C: Center Distance (in),
n_{D}: Speed of Slower Sheave (rpm),
n_{d}: Speed of Faster Sheave (rpm).

Correctly selection of inertia ratio is another essential factor in correct connection of the motor and the Magnetic Generator, which can influence the system performance and selecting the correct size of the motor and other required equipment to connect the motor and the generator. The inertia ratio is defined in Eq. (3):

$$Inertia Ratio = {J}_{I} / {J}_{M} \qquad Eq . ( 3 )$$

where
J_{L}: The inertia of load (kg·m2),
J_{M}: The inertia of motor (kg·m2).

The motor inertia IM can be approximated as the motor's rotor inertia. The load inertia IL is the reflected total load inertia seen by the motor's rotor, including the total inertia of the shaft, couplings, and the Magnetic Generator's rotor.

The inertia ratio is important in terms of
The maximum power delivery from motor to the generator, efficiency and energy saving,
The system stability by avoiding mechanical resonant vibration occurrence and increasing the bandwidth.

The theoretical ideal inertia ratio is 1:1. If the load inertia J_{L} is significantly higher than the motor inertia, the motor will have difficulty controlling the load. If the motor inertia J_{M} is much higher than the load inertia, then the motor is likely oversized, increasing the overall footprint, upfront cost, and cost of operation. The lack of stiffness in the system worsens the inertia mismatch by increasing the inertia ratio and the response times and lowering the system bandwidth. The inertia ratio of the system can be managed by adding gears, belts, or inertia disks to the system {[4]} as described in Gill, H. Energy Management of a Servomotor: Effects of Inertia Ratio-White Paper, Kollmorgen Corporation, 2014.

FIG. 2D is a simplified block diagram of another embodiment of a direct mechanical drive showing a coupling 25 between the shaft of the electric motor 7 and that of the Magnetic Generator 8. It also shows an optional reversing mechanism 23.

### 4) Magnetic Generator

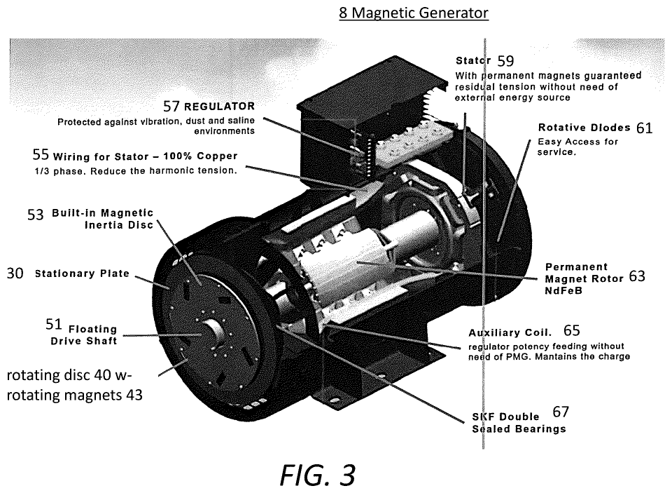

FIG. 3 is a perspective, partially cut-away view of Magnetic Generator 8 with inertial disks compatible with the current invention. Magnetic Generator 8 is technically a Permanent Magnet Generator (PMG), which converts mechanical energy to electrical energy through an electromagnetic induction process. In a PMG 8, the rotor magnetic field is produced by a permanent magnet 63. The rotor of the PMG 63 is connected to a floating drive shaft 51. The floating drive shaft 51 is rotated by an external force, such as electric motor 7, producing a rotating magnetic field within the machine. This rotating magnetic field induces a 3-phase voltage within the stator windings of the PMG 8.

PMGs 8 offer several advantages over the conventional wounded rotor generators; however, they also have some disadvantages {[5]} as described in Rucker, J.E. Design and Analysis of a Permanent Magnet Generator for Naval Applications, Master Thesis, MIT, 2005.

| Advantages | Disadvantages |
|---|---|
| Less complicated | Lack of Inherent voltage regulation |
| No excitation supply or field | Potential Fault currents |
| windings required | Potential demagnetization |
| High efficiency | High-cost permanent magnets |
| High speed applications | |
| Smaller size and weight, and | |
| low maintenance | |

PMGs have no rotor windings, so they do not have field excitation control so voltage regulation can be problematic. These problems can be corrected by applying external voltage controls such as large capacitor banks and power electronics {[5]} as described in Rucker cited above.

In addition, since the permanent magnet field cannot be turned off, there is a risk of excessive currents in the event of an internal fault. This problem can be solved by designing a controller or dynamic braking or using a dump load 8A {[5]} as described in Rucker cited above.

Another issue to consider is the risk of demagnetization of magnets due to rising temperatures. The magnets can be partially or fully demagnetized. In partial demagnetization, the magnetic properties are weakened. But in full demagnetization, the magnetic properties are completely lost and require re-magnetization, which in some cases is impossible and requires a new rotor. Therefore, a thermal study is proposed to ensure that the working temperature of the magnet is maintained within the operating range {[6]} as described in S. Nanda, M. Sengupta, Design, Fabrication and Analytical Investigations on a Permanent Magnet Synchronous Generator, 2014 IEEE International Conference on Power Electronics, Drives and Energy Systems (PEDES), 2014, pp. 1-4.

When designing an electric machine, one of the main concerns is the cost of production. The most expensive part of the PMG 8 is a permanent magnet that can increase the machine price of the machine by 25%. Therefore, the design of a PMG 8 must be optimized to reduce the permanent magnet's size and the generator's size and weight. The most common permanent magnet materials for machine applications are Alnico, Ferrites, SmCo, and NdFeB. The rare-earth magnets, SmCo and NdFeB, have become more popular for high-performance applications due to their higher power density, high flux density, operating temperature, and linearity of the demagnetization curves.

Between the two rare-earth permanent magnets, NdFeB is preferred because it is less expensive and more readily available. The high-power NdFEB magnets are capable of producing flux density of 1.0 to 1.4 Tesla, which is sufficient to saturate the machine. The high magnetic strength can also cause difficulties during the PGM assembly {[5]} as described in Rucker cited above, and {[7]} S. K. Gupta, A. Dwivedi, R. K. Srivastava, Fabrication of Dual-stator Permanent Magnet Synchronous Generator, 2015 Annual IEEE India Conference (INDICON), 2015, pp. 1-5.

Rotating magnets 43 can be mounted on the surface of the rotating disk 40, which is called the surface-mounted method. Alternatively, rotating magnets 43 can be buried in the rotating disk 43, referred to as the interior mounted method. The interior mounted method often results in rotating disks 43 that are larger than equivalent surface-magnet machines with high-energy magnets and has higher torque-generating ability but higher torque ripple. The surface-mounted design allows higher rotational speed with lower torque ripple {[5]} as described in Rucker cited above.

The rotating disk 43 can be merged with a magnetic inertial disk 53 to operate like a flywheel, providing inertial rotational force to continue the rotation.

### 5) Feedback Load Sensing Mechanism 11

In general, magnitude of the induced voltage in the machine depends on the magnetic/electromagnetic flux in the machine, the speed or frequency of rotation, and the machine's construction. In simple form it can be represented by following Eq. (4):

$${E}_{ind} = {K}^{′} ϕ n \qquad Eq . ( 4 )$$

where:
E_{ind}: induced voltage (V),
n: speed (rpm),
ϕ: magnetic flux (Wb),
K′: a constant representing the construction of the machine.

Therefore, the produced voltage can be controlled by flux and/or speed. In wounded-rotor generators, the electromagnetic flux depends on the current flowing in the rotor field circuit. Therefore, the generated voltage can be regulated for different loads by adjusting the rotor field current. However, in PMGs, the magnetic field is generated by permanent magnets, and the rotor has no windings, which makes it difficult to control or regulate the power supplied by the PMGs.

Other parameters affect the voltage supply by the PMG 8 is a change in the speed of the rotor, which can occur due to prime-mover speed change or changes in the load characteristics. As the load current increases the terminal voltage decreases. Therefore, the PMG voltage can be regulated by sensing the load current and adjusting the prime-mover and generator speed accordingly through a feedback system {[8]} as described in Y. Chang, H. Chang, W. Dai, C. Wu, Voltage Regulation and Maximum Output Power Tracking of a 4.5 kW Permanent-magnet Synchronous Generator, 2014 International Power Electronics Conference (IPEC-Hiroshima 2014-ECCE ASIA), 2014, pp. 330-334, and {[9]} Y. Chang, S. Wang, W. Dai and H. Chang, Division-Summation Current Control and One-Cycle Voltage Regulation of the Surface-Mounted Permanent-Magnet Synchronous Generator, in IEEE Transactions on Power Electronics, vol. 31, no. 2, pp. 1391-140 February 2016.

Several advanced speed control techniques of PMGs have been proposed in the literature, based on the line current, rotor's speed and position measurements, and applying conventional or advanced control methods, for instance, Pl controller, T-S fuzzy control, or predictive control methods as described in {[10]} M. Chinchilla, S. Arnaltes, J. C. Burgos, Control of Permanent-Magnet Generators Applied to Variable-Speed Wind-Energy Systems Connected to the Grid, in IEEE Transactions on Energy Conversion, vol. 21, no. 1, pp. 130-135 and {[11]} Chang, Y.-C.; Chang, H.-C.; Huang, C.-Y. Design and Implementation of the Permanent-Magnet Synchronous Generator Drive In Wind Generation Systems, Energies 2018, 11, 1634.

Sensorless control methods of permanent magnet machines have been developed. In the literature based on the position and speed estimation from the current measurements as described in {[12]} M. X. Bui, Sensorless Position Estimation, Parameter Identification and Control Integration for Permanent Magnet Synchronous Machines using Current Derivative Measurements, 2018 International Power Electronics Conference (IPEC-Niigata 2018-ECCE Asia), 2018, pp. 4174-4180 and {[13]} R. Esmaili and L. Xu, Sensorless Control of Permanent Magnet Generator in Wind Turbine Application, Conference Record of the 2006 IEEE Industry Applications Conference Forty-First IAS Annual Meeting, 2006, pp. 2070-2075.

### 6. Combined Use of Solar, Wind, and Storage Batteries for Starting and Running Currents:

When Off-Grid, the system relies heavily on the amount of current needed to start and run the PM Power Generator 8 using a VFD Controlled Electric motor 7. During the daytime, sunlight effectively delivers power using Solar Photo-voltaic Panels 15a and/or Wind Turbine 15b that charges the storage batteries 13. The charged batteries 13 delivers the desired power required by the PM Generator 8. The Variable Speed Drive (VFD) 6 slowly ramps up the current needed by the electric motor 7 until the desired torque is met.

During split-second start-up, the VFD-controlled electric motor 7 ramps up the current up to 50% of the PM Generator 8 load, then brings it down to almost 25% upon reaching the running torque of the PM generator 8. One unique aspect of the current design is how the inertia at the rotor shaft is overcome using the inertial disk 7A in both direct-coupled and V-belt drive designs. This arrangement is coupled by a counter-flow magnet that allows the rotor 63 to disengage, so it is levitated from the stator 59 when rotation at the right speed is met. This phenomenon reduces friction and temperature, allowing smooth operation of the PM Generator 8.

A small amount of current is used to charge the batteries 13 continuously from either solar 15a or wind turbine 15b. Charger Controller 12 and sine wave inverter 14 can provide power to start the operation of the Alternative Power Generation System 1000, according to the present invention.

The whole APG System 1000 is scalable from 10 KW to 1000 KW. Process Logic Control (PLC) simplifies control of the APG System 1000, with screen displays for Voltage, current, phase/cycles, rpm, running totals (data logging), date, and time. With this type of control, remote monitoring is achievable, especially in locations connected by internet/IP address.

The current Alternative Power Generation (APG) System 1000, also referred to as “Magpowgen”, employs an Automatic Transfer Switch (ATS) 6, which connects with an electric power utility, Branch 1A, or to alternative energy sources, “Branch 1B”. APG System 1000 will draw 30% of its rated load to start up. APG System 1000 employs a Variable Speed Drive (VFD) Controller 6 for a soft-slow start. As soon as the desired power (amperage of load) is reached at the desired speed, the VFD controller 6 will maintain this level and ramp down on a split second the running current required by the APG System 1000, normally at 15%-20% of the rated power output of the APG System 1000. Effectively, the APG System 1000 would provide up to 80% of the output load required by the consumer, leaving an average of 20% consumed power.

### Leviotation

The reduction of power consumed (up to 20%) is based on the technological advantage of ‘Leviotation’, which is the art and science of rotating a shaft while in magnetic levitation. (The APG System 1000 employs multiple sets of magnets 43, 33 in a disk to produce a small percentage of torque the drive shaft 51 requires. Inertia Disks 7A, 53 on both the motor 7 shaft and the PM generator 8 provide an amount of force to start and run the rotating disk 40. If both inertia disks are installed at the drive motor shaft and the Magpowgen shaft, both shafts have ‘assisted’ push to start and run, lessening the traction required to break the shaft rotational torque. As long as a magnetic field (repelling) is engaged, this ‘assisted’ push remains constant.

### Sell Power to the Grid

If the consumer produces more power than it needs, Net metering with PPA (power purchase agreement) can be arranged mutually between the Power Utility Company and the consumer. This arrangement will allow the consumer to send the extra power generated through a return meter that measures the amount of power it sells back to the Electric Power Grid.

The consumer is given credit/or cash at the end of the billing cycle.

### Slow Start

Power is provided from a slow start of the electric drive motor from 0-1800 rpm (rated Speed at rated power). Using our ‘Leviotation’ technology, the in-rush current is minimized to its lowest required torque because of the ‘assisted push’ from the inertia disks 7A, and 40 on the drive motor shaft and the Magpowgen 15d drive shaft. The magnetic force between the stationary and rotating magnets 31 and 33 causes both shafts to levitate while rotating. This action reduces the drag or traction, resulting in a smooth and effective current generation.

Due to this ‘assist push’ from the Inertia Disk 7A, the starting and running drive current and torque are considered at the minimum. The size of the solar panels 15a, the wind turbine 15b, and storage batteries 13 would be required to double in size without the current invention's Magternator and Magnetic Inertia Disk Technology.

The idea behind this is that if solar power 15a and/or wind turbine power 15b are not available, the ‘Magternator’ 15d will charge and boost power from the storage battery 13, then batteries' power is converted from DC to AC through an inverter 14. This power is applied to run the drive motor 7 on a slow ramp-up to conserve energy.

### 2. Implementation

FIG. 1 shows a general overall simplified block diagram of the Alternative Power Generation System 1000 according to one embodiment of the current invention.

Electric power from the Utility company delivers electric power to consumers through a metered connection.

A first branch 1A shows power from electric power utility 1 is distributed through a fusible disconnect 2 through a power meter 4 to an automated transfer switch 5.

Power meter 4 measures the power passing through the first branch 1A.

The fusible disconnect 2 functions to break the connection once an excessive amount of power is passing through first branch 1A.

The automated transfer switch (ATS) 5 receives power inputs from first branch 1A and a second branch 1B from alternate energy sources.

If the electric power provided by first branch 1A is acceptable, and the system operator wants to continue using the power from the electric utility, then the automated transfer switch function connects branch 1A with output branch 1C.

### Off-Grid

If power is not connected, or in remote areas where utilities are not available and/or the consumer decides not to use Power Utility Company, then, Magpowgen can work on its own. This arrangement is referred to as “OFF-Grid Installation”.

With the ATS 5 disengaged from the Power Utility Company, the starting current that the Magpowgen would require will come from the combination of Solar Panels 15a and/or Wind Turbines 15b or Gas generator 15c. The current invention design takes into account the use of storage batteries 13. Power generated by either/or Solar Panels 15a or Wind Turbines 15b is stored in the batteries. The Sine-Wave Inverter 14 converts DC power from the batteries 13 to AC power.

### Output Branch 1C

Output branch 1C includes a variable frequency drive motor controller 6, which controls an electric motor 7. Motor 7 and inertial disk 7A work together to drive Magnetic Generator 8, which generates electricity.

Electric power generated by Magnetic Generator 8 is applied to load 10.

Magnetic Generator 8 also includes a dump load mechanism 8A which is engaged to dump off excess power generated by Magnetic Generator 8.

A load sensing mechanism with feedback 11 senses load 10 and provides feedback to the variable frequency drive motor controller 6. This feedback indicates if the drive motor 7 should increase or decrease its rotational speed based on the feedback provided by the load sensing mechanism 11.

Output branch 1C also includes a bank of capacitors 9 which are charged by the electric output of Magnetic Generator 8. These are used as reserve power to start up the output branch 1C after it has been shut down for a period of time.

If alternative transfer switch 5 senses that electric power is being generated by the alternative power sources of branch 1B, it connects branch 1B with output branch 1C.

If an insufficient amount of electric power is generated by the alternative power sources of branch 1B, alternative transfer switch 5 connects branch 1A with output branch 1C.

When the Magnetic Generator 8 is connected to save power and/or provide enough full power, the variable speed drive motor controller 6 varies the speed of drive motor 7 (Soft Start) from a low starting current, ramping up the current required to provide the thrust needed by the drive motor 7 to start and run Magnetic Generator 8.

This arrangement results in Magnetic Generator 8 producing additional power applied to load 10. A load-sensing mechanism 11 senses the load 10 and provides feedback to the Variable Frequency Drive (VFD) motor controller 6 to slow down or speed up electric motor 7 commensurate with the load 10. A small amount of power is sent to a charger controller 12 that feeds a bank of batteries 13 that stores power. This power may be used to activate automated transfer switch 5 to disconnect from the power grid to connect to the bank of batteries 13 to power the load 10 and start and run the Magnetic Generator 8.

Magnetic generator 8 is connected to a dump load 8A that either neutralizes excess load or routes it back to the electric grid 1 for credit.

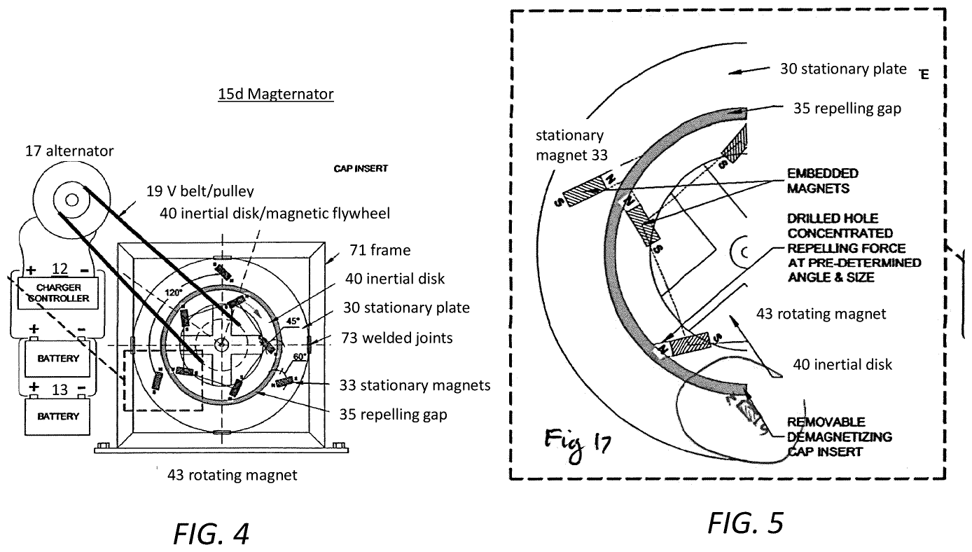

In FIGS. 1 and 4, Magternator 15d is similar to the inertia disk 7A. However, it runs the alternator 17 through belts and pulleys 19. Magternator 15d has a stationary plate 30 comprised of a set of stationary magnets 33 in the stationary plate 31 with North Poles of the stationary magnets 33 pointing at 45 degrees from normal.

There is also a rotating disk 40 having multiple embedded magnets 43 with their North Poles pointing 255 degrees from normal. Positioning the magnets 33 and 43, coupled with a repelling gap 35 of no more than ⅜ inches, will ensure that these magnets will always run on repelling (pushing) motion. The number of magnets in the rotating disk must be 2x more than the magnets on the stationary plates. This arrangement will always make the rotating disk 40 in constant levitation and rotation, referred to as ‘Leviotation’.

Further to this arrangement, as shown in FIG. 1, the output current is also controlled by the load sensing mechanism 11, which indicates back to the VFD 6 that if the load is high, to increase the speed, and if the load is low, to decrease the speed commensurate to the current required.

The current system 1000 also embodies capacitors 9 for additional temporary storage to be used in the starting and running. Capacitors 9 are required when starting and stopping becomes frequent or when monitoring is not possible. A dump load mechanism 8A would discharge unused power to make the current system 1000 safe.

The intended invention may work in several different modes. In the simplest mode, the system is connected to the power grid and referred to as the “ON-GRID Connection”.

The current system may also operate in a mode in which it is connected to alternative electrical power generation systems 15.

The functioning of the Magternator 15d is described with respect to FIGS. 4 and 5. FIG. 4 is a front elevational view of the Magternator 15d as part of an embodiment of the current invention. A stationary circular rotating plate 30 with 3 to 5 stationary magnetics 33 are mounted such that their N-Poles are positioned at 60 Degrees from normal, and a rotating inertia disk 40 with 5 to 7 rotating magnetics 43 positioned and mounted such that N-Poles are positioned at 45 Degrees from normal. This arrangement ensures that the angles of incidence are aligned to provide a continuous rotational force. The positions and number of magnets ensure that there are always 2 or more rotating magnets 43 passing their point of contact with the stationary magnets 33.

When Demagnetizing Cap Insert (not shown) is removed, the rotating disk and magnetic flywheel are energized by the repelling forces between the stationary and rotating magnets 33, 43, causing it to rotate in clockwise direction.

FIG. 5 is an alternative embodiment of the current invention. A more detailed and enlarged diagram of a portion of the APG System of FIG. 1.

A stationary circular plate 30 with 3 to 5 embedded stationary magnets 33 where the N-Poles of each are positioned at 60 Degrees from normal. It also includes a rotating inertia disk 40 with 5 to 7 magnets where N-Poles are positioned at 45 Degrees from normal, ensuring that the angles of contact are not aligned to prevent the stopping of the rotational motion. The position of the plurality of rotating and stationary magnets 33, 43 ensures that there are always 2 or more rotating magnets 43 near the stationary magnets 33 at any point in the rotation of the rotating disk 40.

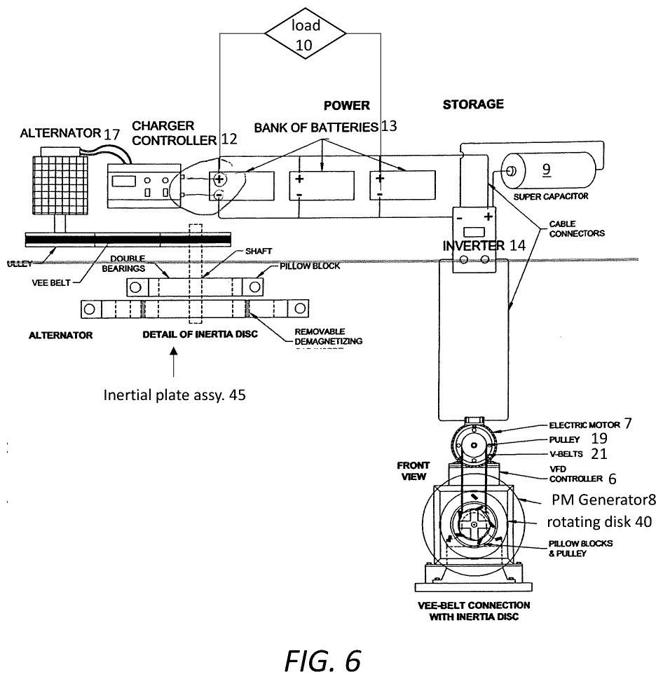

In FIG. 6, the rotating disk 40 drives a PM Generator 17 to provide a small amount of power processed by inverter 14 and then provided to the charger controller 12 that charges the batteries 13. Upon charging of batteries 13, inverter 14 changes DC power to AC, and the VFD soft starts the electric motor from 0-1800 rpm, ramping up the speed and the current delivered to motor 7 that starts and runs the PM Generator 8.

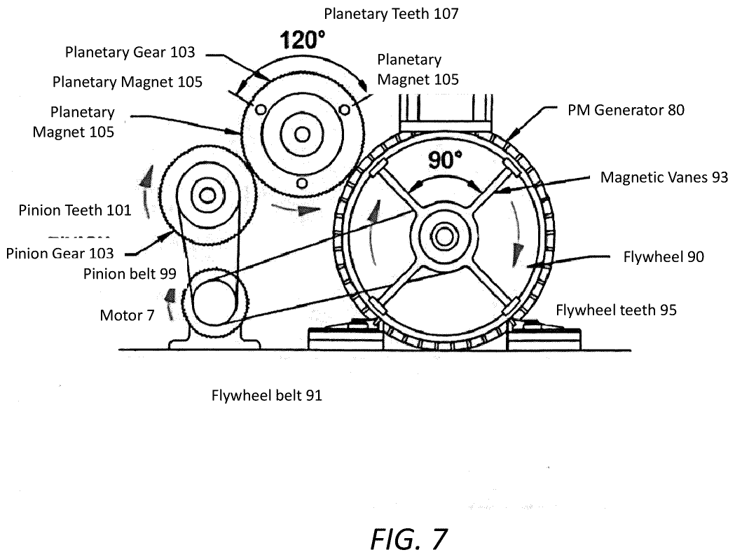

FIG. 7 is a front elevational view of another embodiment of a PM Generator according to the current invention employing planetary gears.

A flywheel 90 is mounted on a shaft driven by the electric motor 7. The flywheel has 4 equally spaced magnetic vanes (each 90 degrees apart) with the north poles at the outer radius of the flywheel 90. The outer radius of the flywheel 90 has a plurality of flywheel teeth 95. Motor 7 runs a flywheel V-belt 91 to turn a pulley on flywheel 90, rotating flywheel 90. Motor 7 also runs a pinion V-belt to turn a pinion gear 97. Pinion gear 97 has a plurality of pinion teeth 101 on its periphery.

Planetary gear 103 has embedded planetary magnets 105, each equally spaced at 120 degrees from each other. Planetary gear 103 also has a plurality of planetary teeth 107 around its periphery. The planetary gear is mounted between the pinion gear 97 and the flywheel 90 such that the planetary teeth 107 of the planetary gear 103 interact with the pinion teeth 101 of the pinion gear 97 and the flywheel teeth 95 of the flywheel 90. As the planetary gear 103 and the flywheel turn, planetary magnets 105 interact with magnetic vanes 93 to produce a rotating force on flywheel 95.

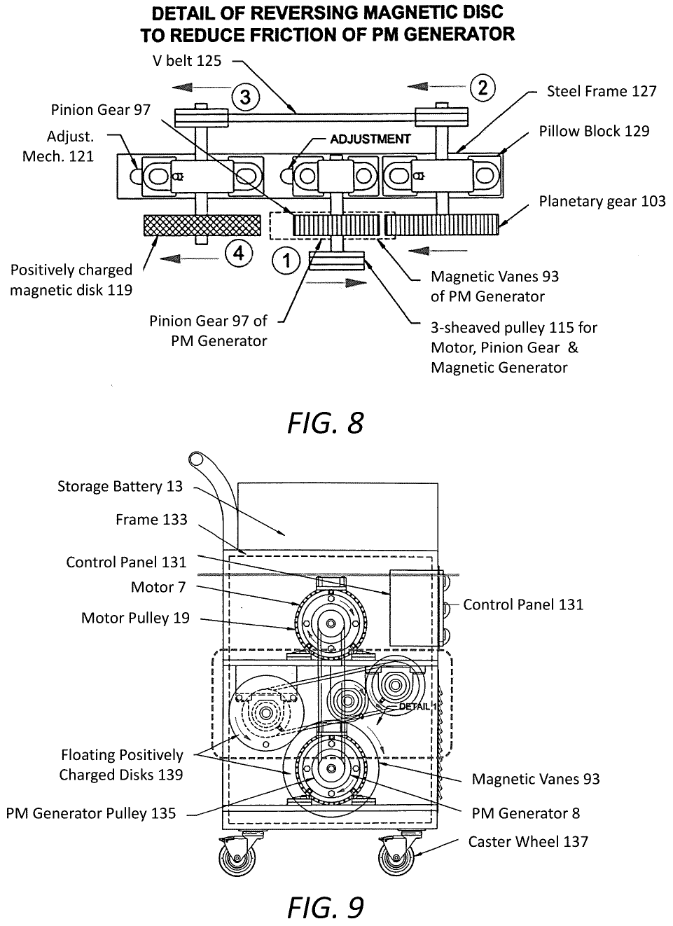

FIG. 8 is a plan view of a reversing magnetic disk 110 used to reduce the friction of a Magnetic Generator. There is a Planetary Gear 11 rotating on a shaft that is held to a frame with a Pillow Block 129. A Positively Charged Magnetic Disk 119 is mounted to the left of the Planetary Gear 111 and spaced away from it.

A 3-sheaved pulley 115 is attached to a Pinion Gear 123. The 3-sheaved pulley has V belts that connect to the Motor, a Pinion Gear, and a Magnetic Generator. The 3-sheaved pulley is connected to a Pinion Gear 123, which interacts with the Magnetic Vanes of the PM generator (not shown here).

The 3-sheaved Pulley and Pinion Gear 123 are attached to a shaft held by an Adjustment Mechanism 121. The Adjustment Mechanism 121 can move the Pinion Gear 97 of the PM Generator to the left or right, causing it to interact with the Planetary Gear 123 or the Positively Charged Magnetic Disk 119.

The Magnets in Pinion Gear 123 and the Magnetic Vanes of the PM Generator Flywheel 90 of FIG. 7 are positioned and angled, as shown in FIG. 7, causing the magnets to repel each other, causing the Leviorotation described above.

When Adjustment Mechanism 121 moves Pinion Gear 123 to the right, it causes the output pulley to rotate in a forward direction. Still, when Adjustment Mechanism 121 moves Pinion Gear to the left, it causes the output pulley to rotate in the opposite direction.

FIG. 9 is a side elevational view of a portable electric generator embodiment of the current invention. Within a frame 133 is an electric motor 7 having a pulley 19 driving a PM Generator 8 using a V belt. Electric power is provided by Storage Batteries 13.

PM Generator 8 in this embodiment has four equally-spaced Magnetic Vanes 93 that interact with 3 magnets in a Planetary Gear 103. There are also Floating Positively Charged Disks 139, which function in a similar manner to the rotating disk 40 described in connection with the previous figures. These act together to cause Leviorotation, similar to that described in connection with FIG. 7. The system is controlled by a Control Panel 131.

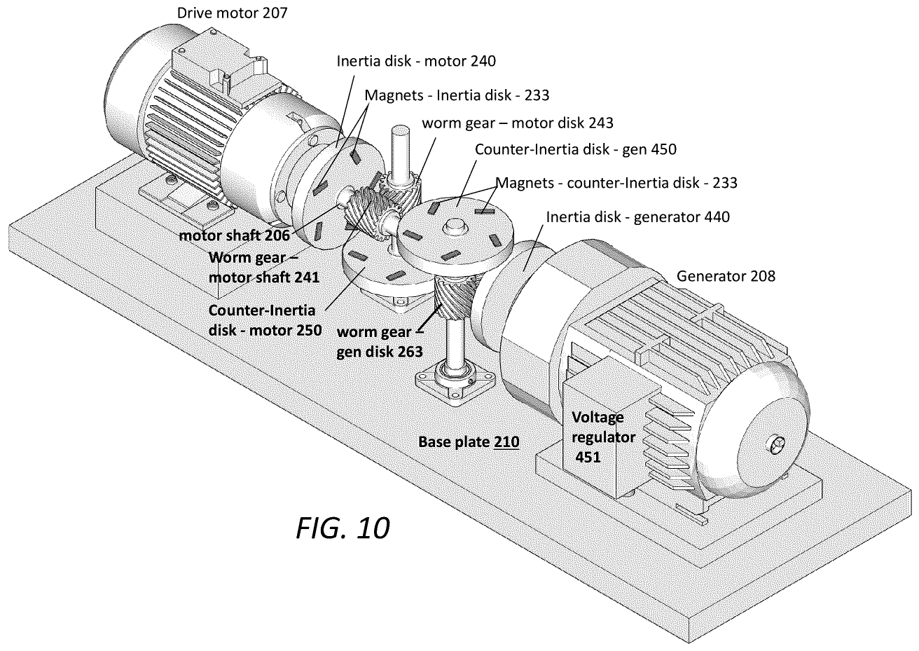

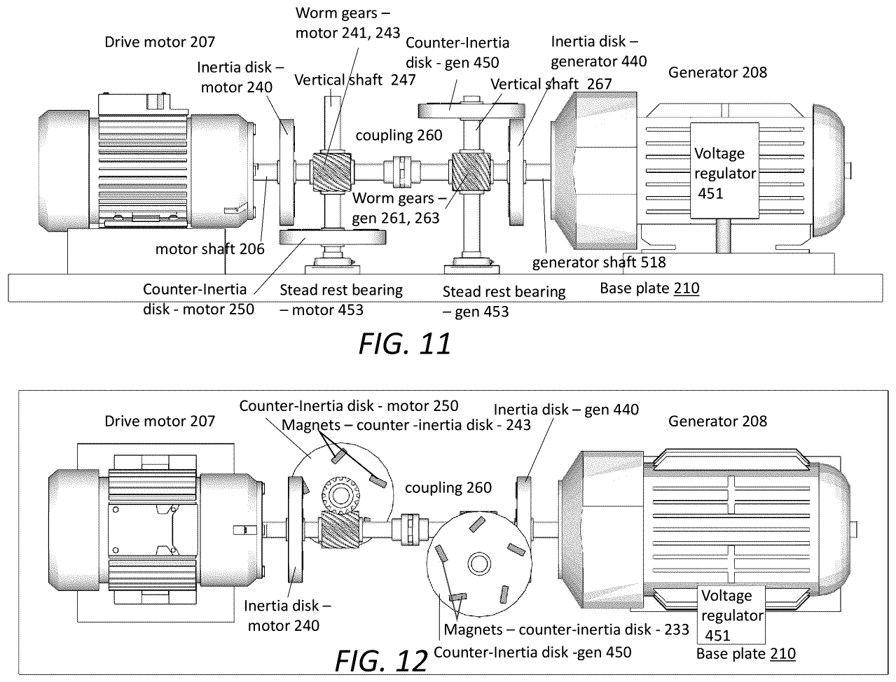

FIG. 10 is a perspective view of another embodiment of the current invention.

FIG. 11 is an elevational view of the embodiment of the current invention shown in FIG. 10.

FIG. 12 is a top plan view of the embodiment of the current invention shown in FIGS. 10 and 11.

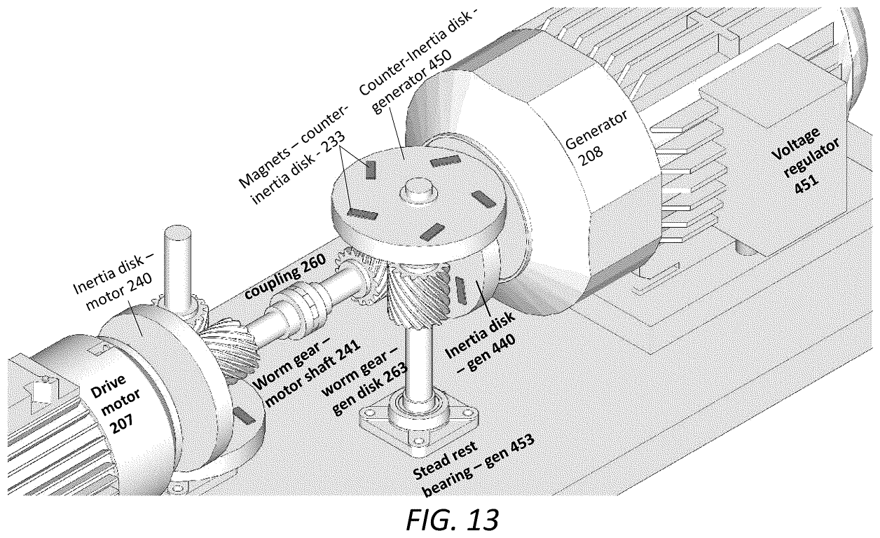

FIG. 13 is an enlarged partial view of the generator portion of the embodiment of FIGS. 10, 11, and 12.

FIGS. 10, 11, 12, and 13 show an embodiment of the current invention that increases the ‘Leviotation’ force on a motor shaft 206 of drive motor 207 and a generator shaft 209 of generator 208. An inertia disk 240 is mounted on drive motor shaft 206. It has embedded magnets 233.

A worm gear 241 is also mounted on motor shaft 206 that interacts with and drives a worm gear 243 mounted on a vertical shaft 247 mounted shaft secured by a stead rest bearing 453 attached to a base 510.

A counter-inertia disk 250 is mounted on the vertical shaft 247 having embedded magnets 243, which are angled and positioned relative to the embedded magnets 233 of the inertial disk 240 to cause magnetic repulsion and add to the Leviorotation force.

Motor shaft 206 is attached to generator shaft 209 by a coupling 260. An inertia disk 440 is mounted on the generator shaft 209. Inertia disk 440 has a plurality of embedded magnets 433.

A worm gear 261 is mounted on generator shaft 209, which interacts with a worm gear 263 mounted on another vertical shaft 267. A second counter-inertia disk 450 is mounted on a vertical shaft 267, having a plurality of embedded magnets 433 positioned and angled such that these magnets 433 repel those of embedded magnets 233 of the inertial disk 240 as they rotate in proximity to each other.

The angle and placement of magnets 433, which are all in repelling motion, are intended to synchronize the repelling forces acting on magnets 233 to push the embedded magnets 233 on the inertia disk. The force imposed on those magnets rotates the disks and the drive shaft connected to it.

These ‘Leviotation’ forces allow the shafts to rotate with much less friction and/or drag, resulting in a much higher net power output generation.

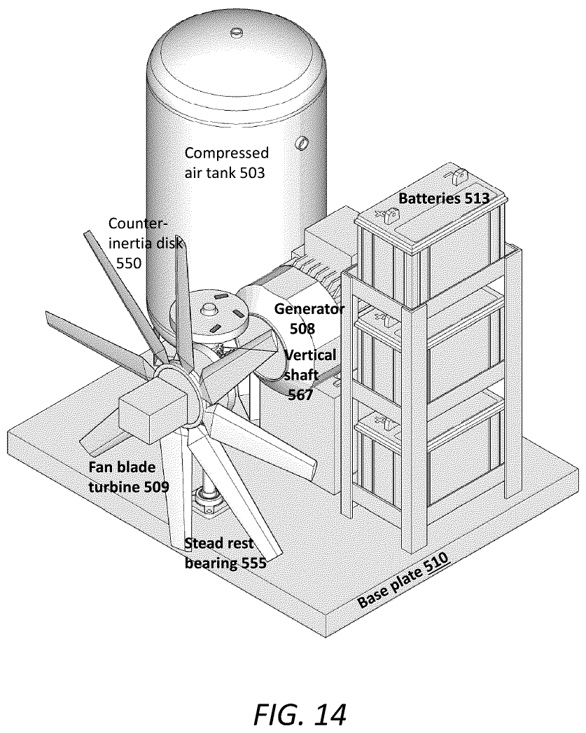

FIG. 14 is a perspective view of another embodiment of the current invention employing compressed air.

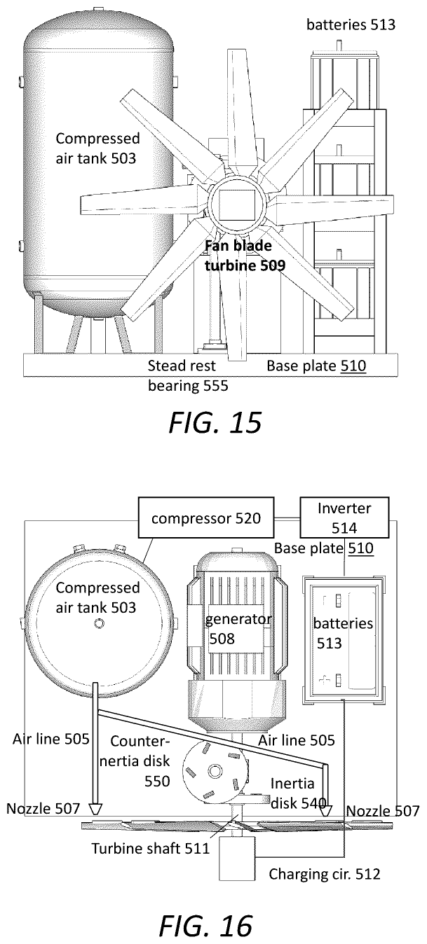

FIG. 15 is a front elevational view of the embodiment of FIG. 14.

FIG. 16 is a top, plan view of the embodiment shown in FIGS. 14 and 15.

The embodiment of FIGS. 14-16 shows another way of recharging batteries 513 using a fan blade turbine 509. Diffuser vanes (not shown) may be attached individually at the back of the fan blade turbine 509.

High-pressure air is stored in a compressed air tank 503. The high-pressure air is provided through air lines 505 to nozzles 507 located near fan blade turbine 509. Nozzles 507 provide a high-pressure stream of jetted air to fan blade turbine 509 that causes its vanes to rotate. The vanes are mounted on a turbine shaft 511.

An inertia disk 540 having magnets 533, similar to that of the previous embodiment, is mounted on turbine shaft 511.

A worm gear 561 is mounted on turbine shaft 511 and interacts with another worm gear 563 mounted on a vertical shaft 567. Vertical shaft 567 is secured to a base plate 510 at a stead rest bearing 555, which allows vertical shaft 567 to rotate.

A counter-inertia disk 550 is also mounted on vertical shaft 567, having a plurality of embedded magnets 543.

The embedded magnets 533 of the inertial disk 540 are positioned and oriented to interact with the embedded magnets 543 to cause ‘Leviorotation’ of the turbine shaft.

The embedded magnets of the inertia disk 540 and the counter-inertia disk 550 are positioned so that each set of magnets repels each other allowing additional torque delivered by the rotation.

The front of turbine shaft 511 is connected to a mechanical-electrical/electronic box (a mechanism that has set gears of increasing speed) that acts as a generator. The small electrical pulses that this electrical box generates are used to recharge batteries 513.

Turbine shaft 511 is directly connected to a generator shaft 518, which rotates generator 508, which charges the bank of batteries 513. The output of the batteries 513 may be connected to a sine-wave inverter 514 that converts DC battery power to AC power. Part of the power is used to power the air compressor 520 that runs intermittently on-demand to fill the compressed air tank 503 with compressed air, later used to turn the fan blade turbine 509. To start the system.

This embodiment is an excellent alternative to a high-altitude Wind Turbine installation, where power generation is dependent on the availability of wind, less noise, and no special permitting is required.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the preceding aspects are illustrative, and no single feature or element is essential to all possible combinations that may be claimed in this or a later application.

What is claimed is:

1. An Alternative Electric Power Generation (APG) System 1000 to supplement electric power to a load in locations that experience intermittent electric power from an electric power grid, comprising:
a) a line input that provides electric line power from the electric power grid;
b) at least one alternative power source that creates electric power;
c) an automatic transfer switch (ATS) coupled to the line input, at least one alternative power source. and a load, that senses electric power being received at the input line and switches to connect the at least one alternative power source to the load when the line power is unavailable.

2. The APG System of claim 1, wherein the at least one alternative power source comprises:
a) a solar energy electrical generation device that converts solar energy into electric power,
b) a gas generator that burns gas and creates electric power,
c) a wind generator that creates electric power from wind; and
d) a magternator that creates electric power from a rotating motor shaft.

3. The APG System of claim 1, wherein the magternator includes an inertial disk assembly comprising:
a) at least one inertial disk on a rotatable shaft, with a plurality of elongated rotating permanent magnets, each having a north pole and a south pole at each end, attached to the inertial plate in regular intervals around its periphery,
b) a stationary plate 30 coplanar with, and concentrically surrounding each inertial disk 40, having a plurality of elongated stationary permanent magnets having a north pole and a south pole at each end, attached to the stationary plate 30 such that the north pole of the rotating magnets passes closely by the north pole of the stationary magnets causing repulsion between the magnets.

4. The APG system 1000 of claim 2 further comprising:
a) a second inertial disk assembly;
b) a magnetic generator;
c) a motor 7 that drives the inertial disk assembly 7A and magnetic generator 6, causing them to create electric power that is applied as output to the load; and
d) a variable frequency drive controller (VFD Controller) that receives power from the ATS, and starts and drives the motor 7 in an energy-efficient manner.

5. The APG system 1000 of claim 2 further comprises:
a) an alternator coupled to and driven by the inertial disk 40 that creates electric power;
b) at least one storage battery for storing electric power;
c) a charger coupled to the alternator and the storage batteries for receiving the power from the alternator and charging the storage batteries.

6. The APG of claim 2, wherein the rotatable magnets are angled with respect to a radial line passing through the inertial disk and rotatable magnets.

7. The APG of claim 2, wherein the stationary magnets are angled with respect to a radial line passing through the inertial disk and the stationary magnets.

8. The APG of claim 2, wherein the inertial disk assembly and the magnetic generator are both mounted on a shaft that is directly connected to a shaft of the motor.

9. The APG of claim 2, wherein the inertial disk assembly and the magnetic generator are directly connected to a shaft of the motor.

10. The APG of claim 2, wherein the motor has a first pulley with a belt that drives a second pulley on a shaft,
a) the inertial disk assembly is mounted on the shaft; and
b) a third pulley is also mounted on the shaft and drives a belt that drives a fourth pulley on the magnetic generator.
